(19) United States
(12) Patent Application Publication
(10) Pub. No.: US 2016/0243448 A1
(43) Pub. Date: Aug. 25, 2016

(54) Virtual Building Block System

(71) Applicant: Linli ZHU, Wuhan (CN)

(72) Inventor: Linli ZHU, Wuhan (CN)

(21) Appl. No.: 14/742,709

(22) Filed: Jun. 18, 2015

(30) Foreign Application Priority Data
Feb. 25, 2015 (CN) 201510087156.2

(51) Int. Cl. A63F 13/80; G03H 1/00; G06F 3/0484

(52) U.S. Cl. CPC A63F 13/80; G06F 3/0484; G03H 1/0005; G03H 2001/0088

(57) ABSTRACT

A virtual building block system includes three-dimensional basic building block units constructed with virtual reality technology, while there is a building block unit library including numerous building block units set on the Internet. A building block unit is a member of a natural object, a member of a artifact, or a member of a natural object and artifact. The building block unit library is opened and allows constructions and designs from the users. There is also an assembly-disassembly platform for assembling and disassembling the building blocks. The building block unit library, assembly-disassembly platform, and a client compose a complete virtual building block system. Such a building block system that is able to cover the entire world or to contain everything in the world, may greatly enhance the effect of intelligence training of building blocks for recreation and inspirations of intelligence and creativity.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a building block based on virtual reality technology for recreation and inspirations of intelligence and creativity.

2. Description of Related Arts

Traditional building blocks are usually cubical wooden or plastic solid toys that normally have letter or picture decorated on each surface and allow for arrangements in different ways for conducting construction exercises. There are many types of building blocks available aimed at developing children's intelligence such as those for assembling houses or different animals.

Building blocks are a type of toys to train children's hand-eye coordination ability as well as potentially enhance the development of their creativity. There are countless combinations children can assemble with building blocks. Various sizes and shapes of building blocks can allow young children to develop their imaginations.

Building blocks originate from architecture models, which use the most basic cubic patterns to create special models. The most successful building blocks generally recognized in the world are from Denmark's company LEGO, which markets in 125 countries in the world and approximately 3 hundred million children have bought LEGO building blocks. Besides LEGO, the most attractive building blocks are square building blocks and 3D square building blocks which have been transformed into Tetris.

However, the basic units of cubic building blocks nowadays are all material and therefore are not able to include everything that one expects to find or wants to have. Conventional building blocks cannot cover every natural and man-made thing. If there is a building block system that is able to cover the entire world or to contain everything in the world, it may greatly enhance the effect of intelligence training of building blocks.

Technology of virtual reality and the Internet nowadays have provided us a technical foundation to make such a building block system come true.

### SUMMARY OF THE PRESENT INVENTION

An object of the present invention is to provide a virtual building block system that is able to cover the entire world or to contain everything in the world to greatly enhance the effect of intelligence training of building blocks.

The technical solution of the present invention is a virtual building block system, which includes three-dimensional basic building block units, wherein the three-dimensional building block units are constructed with virtual reality technology, a building block unit library comprising numerous building block units set on the Internet, a building block unit library being opened and allowing constructions and designs from the users, and an assembly-disassembly platform for assembling and disassembling the building blocks. The building block unit library, the assembly-disassembly platform, and a client together compose one complete virtual building block system.

The virtual building block system mentioned above is characterized in that the building block unit is a member of a natural object, a member of a artifact, or a member of a natural object and artifact.

The virtual building block system mentioned above is characterized in that the building block unit can be a architecture member, such as a brick, a pillar, a tile, or a board, an electronic component, such as a diode, an audion, a resistance, a capacitor, a power source, an electric motor, or an electric brush, a clothing component, such as a piece of fabric, a thread, a button, a zipper, a collar, a cuff, or a pocket, a mechanical component, such as a wheel, a girder, an engine, a steering wheel, a gear, a transmission, or an universal joint, a member of human body, such as a head, a hand, a foot, a leg, a heart, a brain, a lung, a blood vessel, a nerve, a muscle, or a bone, a member of plant, such as a straw, a stem, a root, a flower, a leaf, a bud, or a core, or a member of animal.

The virtual building block system mentioned above is characterized in that the virtual building block system further includes a target library putting natural objects and/or artifacts. A simple way of restoration is to ensure the restoring order of the components as the natural objects or artifacts are disassembled that a program automatically moves the components to the correct restoring places. An advanced way of restoration is to follow a real process of assembling to move and turn the virtual components to the correct restoring places.

The virtual building block system mentioned above is characterized in that programs of the building block unit library and the assembly-disassembly platform are running on a central server. The client only sends requests to the central server and views results processed by the programs of the central server.

The virtual building block system mentioned above is characterized in that the virtual building block system has placed a variety of the central servers separately. The distance of the separation is far enough for placing two of the central servers in different countries.

The virtual building block system mentioned above is characterized in that the virtual building block system further has a laser holographic projection device projecting the virtual building block unit or an assemblage thereof from the computer to be a three-dimensional holographic image.

Because the virtual building block system is set on the Internet, its building block units are also constructed or designed by the users, and its building block unit library is open for any person to add into. The virtual building block system would have the capability of expanding, covering everything, and lacking nothing.

If people need anything that has not been included in the library, anyone can use virtual reality technology to add it into the library.

A building block unit newly designed or constructed by a user is shared to all other clients, so as to maximize resource sharing.

These and other objectives, features, and advantages of the present invention will become apparent from the following detailed description, the accompanying drawings, and the appended claims.

### BRIEF DESCRIPTION OF THE DRAWINGS

### Detailed Description of the Preferred Embodiment

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The virtual building block system requires to first build a platform website on the Internet, and to then set up a building block unit library for storing virtual building block units and an assembly-disassembly platform. The assembly-disassembly platform can also be on the client or on both of the platform website and the client. The platform website on the Internet links to the clients all over the world.

The building block unit library is opened to all of the Internet clients, wherein a user can freely apply virtual reality technology to build building block units or components, such as bricks, pillars, tiles, boards, screws, nuts, nails, lead rails, cables, lamps, and switches, and add them into the building block unit library.

“The building block unit or component” can also be defined in various levels. For example, a brick is a component of a house, but a sand grain and soil are components of a brick. Similarly, a lamp is a component of a building, but a filament is a component of a lamp.

Common sense formed by most people may be applied to label that which objects are components, which objects are subassemblies, and which objects are targets.

A building block unit or component can be a monomer, and can also be a composited multibody.

It can be started from disassembling objects.

A whole of a certain object or theme is first constructed. Then parts are disassembled from the whole (or so called assemblage or target) one by one. Next, the whole is assembled again.

For instance, a watch is first constructed. Then its parts are taken off one after one. Then those parts are put back one after one.

A washing machine is first constructed. Then its parts are dismantled one after one and then put back one after one to restore the machine.

A human body, an animal, a plant, a microorganism, a tool, an utensil, an instrument, equipment, a weapon, a machine tool, a production line, an assembly line, an earth, a celestial body, and so on can all be constructed.

All components for disassembling are designed beforehand and the assemblage is assembled in advance. There are correct assembling relations among the components.

The components or parts are put into the building block unit library, and the assemblages are put into the target library.

A simple way of restoration is to only ensure the restoring order of the components and let the program automatically move the components to the correct restoring places.

An advanced way of restoration is to follow a real process of assembling to move and turn the virtual components to the correct restoring places.

The building block units can be resized easily to adapt for the needs of the sizes of the components from diverse assemblages.

The new things that people assembled in the virtual building block system should be saved in the system.

The steps of how people assemble and disassemble the components in the virtual building block system should be saved in the system.

The way of saving can be with a form of image showing as well as a form of non-image, verbal, or digital record.

Considering the difficulty of implementing virtual reality technique with an Internet client's capability, a solution is to make both the construction of the building block units and the assembling and disassembling of the building block be implemented on a high performance central server, while the clients just sent requests to the central server and view the results processed by the central server.

Certainly, it will be the best if the virtual reality software applied is able to run on the client's computer, so as to avoid lags on the central server and to enhance the privacy of personal activities.

The virtual building block system of the present invention does not only help children's intelligence training in recognizing natural objects and artifacts, but also help adults in enhancing their intelligence and creativity.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A virtual building block system, comprising three-dimensional basic building block units being constructed with virtual reality technology, a building block unit library comprising numerous building block units set on the Internet, a building block unit library being opened and allowing constructions and designs from the users, and an assembly-disassembly platform for assembling and disassembling the building blocks, wherein said building block unit library, said assembly-disassembly platform, said internet, and a client compose one complete said virtual building block system, wherein said virtual building block system further comprises a target library which is putting detachable natural objects and/or artifacts, wherein all components for disassembling are designed beforehand and the assemblage is assembled in advance, wherein the components are put into said building block unit library and the assemblages are put into said target library.

2. The virtual building block system, as recited in claim 1, wherein at least one of said building block units is selected from a group consisting of a member of a natural object, a member of a artifact, and a member of a natural object and artifact.

3. The virtual building block system, as recited in claim 2, wherein said building block unit is selected from a group consisting of:
an architecture member, adapted to be selected from a group consisting of a brick, a pillar, a tile, and a board;
an electronic component, adapted to be selected from a group consisting of a diode, an audion, a resistance, a capacitor, a power source, an electric motor, and an electric brush;
a clothing component, adapted to be selected from a group consisting of a piece of fabric, a thread, a button, a zipper, a collar, a cuff, and a pocket;
a mechanical component, adapted to be selected from a group consisting of a wheel, a girder, an engine, a steering wheel, a gear, a transmission, and an universal joint;
a member of human body, adapted to be selected from a group consisting of a head, a hand, a foot, a leg, a heart, a brain, a lung, a blood vessel, a nerve, a muscle, and a bone;
a member of plant, adapted to be selected from a group consisting of a straw, a stem, a root, a flower, a leaf, a bud, and a core; and
a member of animal.

4. The virtual building block system, as recited in claim 2, wherein said virtual building block system further comprises a target library putting natural objects and/or artifacts, wherein a simple way of restoration is to ensure the restoring order of the components as said natural objects or artifacts are disassembled that a program automatically moves the virtual components to the correct restoring places, wherein an advanced way of restoration is to follow a real process of assembling to move and turn the virtual components to the correct restoring places.

5. The virtual building block system, as recited in claim 1, wherein programs of said building block unit library and said assembly-disassembly platform are running on a central server, wherein said client only sends requests to said central server and views results processed by said programs of said central server.

6. The virtual building block system, as recited in claim 5, wherein said virtual building block system has a variety of said central servers placed separately, wherein the distance of the separation is far enough for placing two of said central servers in different countries.

7. The virtual building block system, as recited in claim 5, wherein said virtual building block system further has a laser holographic projection device projecting said virtual building block unit or an assemblage thereof from the computer to be a three-dimensional holographic image.

8. The virtual building block system, as recited in claim 2, wherein programs of said building block unit library and said assembly-disassembly platform are running on a central server, wherein said client only sends requests to said central server and views results processed by said programs of said central server.

9. The virtual building block system, as recited in claim 8, wherein said virtual building block system has a variety of said central servers placed separately, wherein the distance of the separation is far enough for placing two of said central servers in different countries.

10. The virtual building block system, as recited in claim 8, wherein said virtual building block system further has a laser holographic projection device projecting said virtual building block unit or an assemblage thereof from the computer to be a three-dimensional holographic image.

11. The virtual building block system, as recited in claim 3, wherein programs of said building block unit library and said assembly-disassembly platform are running on a central server, wherein said client only sends requests to said central server and views results processed by said programs of said central server.

12. The virtual building block system, as recited in claim 11, wherein said virtual building block system has a variety of said central servers placed separately, wherein the distance of the separation is far enough for placing two of said central servers in different countries.

13. The virtual building block system, as recited in claim 11, wherein said virtual building block system further has a laser holographic projection device projecting said virtual building block unit or an assemblage thereof from the computer to be a three-dimensional holographic image.

14. The virtual building block system, as recited in claim 1, wherein said building block units can be resized easily to adapt for the needs of the sizes of the components from diverse assemblages.

15. The virtual building block system, as recited in claim 4, wherein said building block units can be resized easily to adapt for the needs of the sizes of the components from diverse assemblages.

16. The virtual building block system, as recited in claim 4, wherein the new things that people assembled in said virtual building block system should be saved in the system.

17. The virtual building block system, as recited in claim 4, wherein the steps of how people assemble and disassemble the components in said virtual building block system is saved in the system with a form of image showing as well as a form of non-image, verbal, or digital record.
